(19) United States
(12) Patent Application Publication
(10) Pub. No.: US 2026/0090576 A1
(43) Pub. Date: Apr. 2, 2026

(54) FLAVORING COMPOSITIONS HAVING A ROAST AROMA PROFILE

(71) Applicant: Firmenich SA, Satigny (CH)

(72) Inventors: Darrel FLETCHER, Vienna (AT); Tania HAHN, Vienna (AT); Robert WAGNER, Satigny (CH)

(73) Assignee: Firmenich SA, Satigny (CH)

(21) Appl. No.: 19/110,523

(22) PCT Filed: Sep. 14, 2023
(86) PCT No.: PCT/EP2023/075326

§ 371 Date: Mar. 11, 2025

(30) Foreign Application Priority Data
Sep. 21, 2022 (EP) 22196813.4

(51) Int. Cl. A23L 27/10; A23J 3/22; A23L 13/40; A23L 27/20

(52) U.S. Cl. CPC A23L 27/115; A23J 3/227; A23L 13/428; A23L 27/202; A23L 27/2028; A23L 27/203; A23L 27/204; A23L 27/2052; A23L 27/2056

(57) ABSTRACT

The present disclosure relates generally to flavoring compositions having a roast aroma profile and their use in flavored consumer products. In certain aspects, the disclosure also provides methods for the preparation of such flavoring compositions.

### TECHNICAL FIELD

The present disclosure relates generally to flavoring compositions having a roast aroma profile and their use in flavored consumer products. In certain aspects, the disclosure also provides methods for the preparation of such flavoring compositions.

### BACKGROUND

Roast aroma flavoring compositions which mimic the taste and smell of grilled or cooked foods are popular additives in consumable products. For example, such flavorings have a long use in preparing meats, cheese, fish, snacks. Furthermore, in recent years there has been an increase in the popularity of fake meat and vegetarian substitutes for health and environmental reasons. The use of roast flavoring compositions in such food stuffs is desirable from a consumer perspective.

Presently many roast aroma flavoring compositions are derived from using smoke condensates which can be obtained from wood combustion and condensing the smoke. The resulting smoke condensate (liquid smoke) is purified, further processed and used in foods to confer roast aroma. However, smoke condensates obtained by wood combustion at high temperatures can include toxic compounds such as polycyclic aromatic hydrocarbon(s) (PAH). This can mean that smoke condensates obtained from wood combustion can be regarded as unsafe or not natural by regulatory legislation, for example in the EU.

Hence there is a need to develop flavoring compositions having roast aroma profile but without problematic amounts of toxic compounds such as polycyclic aromatic hydrocarbon(s) (PAH).

The aim of the present invention is to provide such flavoring compositions.

### BRIEF DESCRIPTION OF THE DRAWINGS

FIG. 1. Formation of phenolic compounds from ferulic acid

FIG. 2. Chemical structure of target phenols (numbers refer to Table 1)

FIG. 3. Guaiacol formation during roasting of rice bran at various temperatures

FIG. 4. Influence of cereal variety on phenol formation (235° C., 5 h)

FIG. 5. Influence of other parameters on phenol formation (conditions in Table 4)

FIG. 6. Test result of a product incorporating the flavoring composition of the invention. Significance results: *=95%, **=99%, ***=99.9%

### DETAILED DESCRIPTION

The present invention provides a flavoring composition having roast-like aroma profile comprising (i) one or more aroma compound(s) selected from a first group comprising: 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol E-isoeugenol, Z-isoeugenol, 4-vinyl phenol, 4-propyl guaiacol and 2,6-dimethoxyphenol; and (ii) one or more of compounds selected from a second group comprising: methylcyclopentenolone, furfuryl, furfural, furaneol, and thiazoline, characterized in that the composition has less than 300 ppb of polycyclic aromatic hydrocarbon(s) and/or acrylamide.

An embodiment of the invention is wherein the second group further comprises one or compounds selected from: ethyl lactate, thymol and trimethylamine.

As used herein the term “PAH” means polycyclic aromatic hydrocarbon(s).

Flavoring composition having roast aroma profile are popular additives to a variety of consumer products. However increasing awareness concerning the toxicity of certain compounds produced by the preparation process has led to some countries and jurisdictions introducing minimal acceptable quantities of such compound in food stuffs for human consumption. For example EU regulations limits the amount of PAH and acrylamide in food additives profiles. The PAH benzo[a]pyrene (BaP) is limited to 10 ppb. Acrylamide is another potentially toxic compound in thermally treated food. The benchmark level in the EU is 300 ppb in cereal products.

Existing methods of preparing flavoring composition having roast aroma profile involve using wood-based starting materials which are heated for a prolongued period of time at a high temperature. With such starting materials such reaction conditions increase the likelihood of PAH and acrylamide formation.

The roast aroma profile of flavoring composition are primarily due to the presence of certain phenolic compounds.

Hence it is a purpose of the present invention to prepare a flavoring composition having roast aroma profile which has a sufficient amount of aroma compound(s) while at the same time reducing the levels of PAH and acrylamide to an acceptable amount.

As provided below, the inventors have devised a new innovative process which significantly reduces the quantity of PAH and acrylamide to an acceptable amount while at the same time having a sufficient amount of aroma compounds. As can be seen in the accompanying examples this results in a flavoring composition having attractive aroma performances. For example the aroma is suggested as being capable of imparting roast profile, charred notes to meat flavors, particularly pork and bacon.

By “roast aroma profile” we include where the flavoring composition of the invention imparts a taste and/or smell reminiscent of roasted meats, including smoky and ashy flavor notes. The term is well known in the field of flavoring. For example, it is known to refer to something that has a roast flavor and tastes like it has been roasted. The term would hence be clearly understood to the person expert in this field.

The aroma profile is provided by aroma compounds. The “aroma compounds” are selected from the group comprising: 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol E-isoeugenol, Z-isoeugenol, 4-vinyl phenol, 4-propyl guaiacol and 2,6-dimethoxyphenol.

The compounds are well known in the art and can be detected and measured using commonly known analytical methods, examples of which are provided in the accompanying examples.

It can be appreciated by the skilled person that the flavoring composition can comprise one or more of the aroma compounds listed herein. For example, the composition can comprise at least two aroma compounds, preferably least three aroma compounds, preferably least five aroma compounds, preferably least seven aroma compounds, preferably least nine aroma compounds, preferably least ten aroma compounds, preferably least eleven aroma compounds, preferably least twelve aroma compounds, preferably least thirteen aroma compounds, preferably least fourteen aroma compounds, preferably least fifteen aroma compounds, selected from the group comprising: 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol E-isoeugenol, Z-isoeugenol, 4-vinyl phenol, 4-propyl guaiacol and 2,6-dimethoxyphenol.

In a preferred embodiment of the invention flavoring composition comprises 2-methyl phenol, 3-methyl phenol, 4-methyl phenol, 3-ethyl phenol, 4-ethyl phenol, guaiacol, 4-methyl guaiacol, 4-ethyl guaiacol, 4-vinyl guaiacol, eugenol E-isoeugenol, Z-isoeugenol, 4-vinyl phenol, 4-propyl guaiacol and 2,6-dimethoxyphenol.

A preferred embodiment of the invention is wherein one or more of the aroma compounds selected from the group comprising: 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol E-isoeugenol, Z-isoeugenol, 4-vinyl phenol, 4-propyl guaiacol and 2,6-dimethoxyphenol, are present in an amount of at least 0.05 ppm of the flavoring composition.

Preferably the composition can comprise at least two aroma compounds, preferably least three aroma compounds, preferably least five aroma compounds, preferably least seven aroma compounds, preferably least nine aroma compounds, preferably least eleven aroma compounds, preferably least thirteen aroma compounds, preferably least fourteen aroma compound selected from the group comprising: 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol E-isoeugenol, Z-isoeugenol, 4-vinyl phenol, 4-propyl guaiacol and 2,6-dimethoxyphenol are present in an amount of at least 0.05 ppm of the flavoring composition.

In a preferred embodiment of the invention the aroma compounds comprise 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol E-isoeugenol, Z-isoeugenol, 4-vinyl phenol, 4-propyl guaiacol and 2,6-dimethoxyphenol and the amount of aroma compounds is approximately 590 ppm or less.

In a preferred embodiment of the invention the aroma compounds consist of 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol E-isoeugenol, Z-isoeugenol, 4-vinyl phenol, 4-propyl guaiacol and 2,6-dimethoxyphenol and the amount of aroma compounds is approximately 590 ppm or less.

The composition of the invention further comprises one or more of compounds selected from a second group comprising: methylcyclopentenolone, furfuryl, furfural, furaneol, and thiazoline. An embodiment of the invention is wherein the second group further comprises one or compounds selected from: ethyl lactate, thymol and trimethylamine.

The compounds of this group of the invention can act to enhance the flavor profile of the composition of the invention,

Preferably the composition of the invention comprises least two compounds, preferably least three compounds, preferably least four compounds, preferably least five compounds preferably least six compounds preferably least seven compounds selected from the second group comprising: methylcyclopentenolone, furfuryl, furfural, furaneol, and thiazoline.

Further compounds can be added to the composition of the invention to enhance the roast flavoring. These include pyrazines such as dimethyl pyrazine, trimethyl pyrazine, ethyl methyl pyrazine, ethyl dimethyl pyrazine and acetyl pyrazine; furfuryls such as furfuryl mercaptan, furfuryl thioacetate and methyl furfural; acetic acid; furanthiols such as 2-methyl-3-furanthiol and tetrahydromethylfuranthiol; trimethylamine; and sotolone

In an embodiment of the invention the flavor composition comprises aroma compounds comprising of 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol; and the flavor composition further comprises methylcyclopentenolone, furfuryl, furfural, furaneol, thiazoline, ethyl lactate, thymol and trimethylamine; pyrazines such as dimethyl pyrazine, trimethyl pyrazine, ethyl methyl pyrazine, ethyl dimethyl pyrazine and acetyl pyrazine; furfuryls such as furfuryl mercaptan, furfuryl thioacetate and methyl furfural; acetic acid; furanthiols such as 2-methyl-3-furanthiol and tetrahydromethylfuranthiol; trimethylamine; and sotolone.

The flavoring composition of the invention is characterized by having less than 300 ppb of polycyclic aromatic hydrocarbon(s) and/or acrylamide.

Polycyclic aromatic hydrocarbon(s) (PAH) compounds are well known and well defined in the art.

A polycyclic aromatic hydrocarbon (PAH) is a hydrocarbon that is composed of multiple aromatic rings. The simplest of such chemicals are naphthalene, having two aromatic rings, and the three-ring compounds anthracene and phenanthrene. The terms polyaromatic hydrocarbon or polynuclear aromatic hydrocarbon are also used for this concept.

PAHs are uncharged, non-polar molecules, with distinctive properties due in part to the delocalized electrons in their aromatic rings. Many of them are found in coal and in oil deposits, and are also produced by the thermal decomposition of organic matter, for example, in engines and incinerators or when biomass burns in forest fires.

Examples of PAH include naphthalene, acenaphthylene, acenaphthene, fluorene, phenanthrene, anthracene, fluoranthene, pyrene, benzo(a)anthracene, chrysene, benzo[b]fluoranthene, benzo[k]fluoranthene, benzo[a]pyrene, indeno[1,2,3-c,d]pyrene, dibenzo[a,h]anthracene, benzo[g,h,i]perylene, benzo[j]fluoranthene, cyclopenta[cd]pyrene, dibenzo[a,e]pyrene, dibenzo[a,h]pyrene, dibenzo[a,i]pyrene, dibenzo[a,l]pyrene, 5-methylchrysene, benzo(c)fluorene. The reference PAH is benzo[a]pyrene.

Again, they can be detected and measured using commonly known analytical methods, examples of which are provided in the accompanying examples.

In another embodiment the PAH is benzo[a]pyrene and is less than 10 ppb, preferably less than 5 ppb, more preferably less than 4 ppb, more preferably less than 3 ppb, more preferably less than 2 ppb, more preferably less than 1 ppb, or less.

In a preferred embodiment the flavoring composition has less than 300 ppb acrylamide, preferably less than 200 ppb, more preferably less than 100 ppb, more preferably less than 50 ppb, more preferably less than 20 ppb, more preferably less than 10 ppb, or less.

In a preferred embodiment of the invention the flavoring composition is prepared from a cereal bran.

As used herein “cereal bran” refers to the outer coating or shell a grain and can consist of the pericarp, the seed coat, and the aleurone layer. Examples of cereal brans suitable for the method of preparing the composition of the invention include bran from rice, corn, wheat, oat, rye, barley, sorghum and spelt.

The present inventors performed a series of experiments which are outlined in the accompanying examples. Within these experiments they measured the amount of aroma compounds which could be prepared from different cereal brans.

Accordingly, where the cereal bran is corn the aroma compounds comprise 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 1841.3 ppm or less. Preferably the amount of aroma compounds is approximately 590 ppm or less.

Preferably, the cereal bran is corn and the aroma compounds consist of 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 1841.3 ppm or less. Preferably the amount of aroma compounds is approximately 590 ppm or less.

In another embodiment the cereal bran is wheat, and the aroma compounds comprise 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 792.4 ppm or less. Preferably the amount of aroma compounds is approximately 320 ppm or less.

Preferably, the cereal bran is wheat, and the aroma compounds consist of 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 792.4 ppm or less. Preferably the amount of aroma compounds is approximately 320 ppm or less.

In another embodiment the cereal bran is rice and the aroma compounds comprise 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 2005.2 ppm or less. Preferably the amount of aroma compounds is approximately 270 ppm or less.

Preferably the cereal bran is rice and the aroma compounds consist of 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 2005.2 ppm or less. Preferably the amount of aroma compounds is approximately 270 ppm or less.

In another embodiment the cereal bran is spelt and the aroma compounds comprise 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 190 ppm or less.

Preferably the cereal bran is spelt and the aroma compounds consist of 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 190 ppm or less.

In another embodiment the cereal bran is rye and the aroma compounds comprise 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 160 ppm or less.

Preferably the cereal bran is rye and the aroma compounds consist of 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 160 ppm or less.

In another embodiment the cereal bran is sorghum and the aroma compounds comprise 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 110 ppm or less.

Preferably the cereal bran is sorghum and the aroma compounds consist of 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 110 ppm or less.

In another embodiment the cereal bran is oat and the aroma compounds comprise 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 110 ppm or less.

Preferably the cereal bran is oat and the aroma compounds consist of 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 110 ppm or less.

In another embodiment the cereal bran is barley and the aroma compounds comprise 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 42 ppm or less.

Preferably the cereal bran is barley and the aroma compounds consist of 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 42 ppm or less.

In a preferred embodiment the cereal bran is corn and the aroma compounds comprise of 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol and the flavor composition further comprises methylcyclopentenolone, furfuryl, furfural, furaneol, thiazoline, ethyl lactate, thymol and trimethylamine.

In an embodiment of the invention the flavor composition comprises aroma compounds comprising of 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol and the flavor composition further comprises methylcyclopentenolone, furfuryl, furfural, furaneol, thiazoline, ethyl lactate, thymol and trimethylamine; and pyrazines such as dimethyl pyrazine, trimethyl pyrazine, ethyl methyl pyrazine, ethyl dimethyl pyrazine and acetyl pyrazine; furfuryls such as furfuryl mercaptan, furfuryl thioacetate and methyl furfural; acetic acid; furanthiols such as 2-methyl-3-furanthiol and tetrahydromethylfuranthiol; trimethylamine; and sotolone

In a preferred embodiment, the composition is an aqueous composition or a powdered composition, more preferred a powdered composition. Aqueous composition means that the entirety of extracted material is present in solution, wherein the solvent comprises water. Powdered composition means that the entirety of extracted material is present in solid, powdered form.

A further aspect of the invention provides the use of a composition as defined in any of the previous embodiments of the invention for providing a roast aroma to a flavoring composition.

Hence the composition for use in this method of the invention comprises one or more aroma compound(s) selected from the group comprising: 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol E-isoeugenol, Z-isoeugenol, 4-vinyl phenol, 4-propyl guaiacol and 2,6-dimethoxyphenol, characterized in that the composition has less than 300 ppb of polycyclic aromatic hydrocarbon(s) and/or acrylamide. All other embodiments of the invention described herein in relation to the composition are included in this aspect of the invention, including the type and amount of aroma compounds.

As discussed above the present inventors have developed a new innovative process which significantly reduces the quantity of PAH and/or acrylamide to an acceptable amount while at the same time having a sufficient amount of aroma compounds.

Hence a further aspect of the invention provides a method of preparing a flavoring composition of the invention comprising:
(i) heating cereal bran to a temperature of 200-250° C. for between 1 to 5 hours without the addition of exogenous water.
(ii) collecting the flavoring composition produced by step (i),
(iii) adding one or more of compounds selected from a second group comprising: methylcyclopentenolone, furfuryl, furfural, furaneol, and thiazoline.

An embodiment of this aspect of the invention is wherein the second group further comprises ethyl lactate, thymol and trimethylamine.

As described above aroma compound(s) impart taste and/or smell reminiscent of roast. Typical “aroma compounds” are often derived from phenols. Phenylpropanoic acids like coumaric, ferulic and sinapic acid are precursors for such phenols. Therefore when devising the present invention the inventors selected cereal bran as a staring material since they are rich in ferulic and other phenylpropanoic acids, inexpensive, but have food status.

As used herein “cereal bran” refers to the outer coating or shell a grain and can consist of the pericarp, the seed coat, and the aleurone layer. Examples of cereal brans suitable for use the method of preparing the composition of the invention include bran from rice, corn, wheat, oat, rye, barley, sorghum and spelt.

Preferably the cereal bran is rice, corn or wheat bran.

In step (i) of the method of the invention the cereal bran is heated at temperature of 200-250° C. for between 1 to 5 hours without the addition of exogenous water. The selection of a temperature of 200-250° C. is important since it is lower than the temperatures typical used to prepare roast extracts from wood based starting materials and will lead to lower amount of PAH in the composition. Since some countries require that food preparations are prepared below an upper limit of 240° C., preferably a temperature of 200-240° C. is used.

The time of between 1 to 5 hours is selected since it is within this window that the most amount of aroma compound(s) will be generated.

The present inventors preformed a series of experiments which are outlined in the accompanying examples. Within these experiments they measured the amount of aroma compounds which could be prepared from cereal brans heated to different temperatures for around 5 hours.

Hence an embodiment of the present method of the invention is wherein the cereal bran is heated to 200° C. for 5 hours and the aroma compounds in the flavoring composition comprise 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 77 ppm or less. Preferably the cereal bran is rice bran.

Preferably the cereal bran is heated to 200° C. for 5 hours and the aroma compounds in the flavoring composition consist of 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 77 ppm or less. Preferably the cereal bran is rice bran.

Hence an embodiment of the present method of the invention is wherein the cereal bran is heated to 220° C. for 5 hours and the aroma compounds in the flavoring composition comprise 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 140 ppm or less. Preferably the cereal bran is rice bran.

Preferably the cereal bran is heated to 220° C. for 5 hours and the aroma compounds in the flavoring composition consist of 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 140 ppm or less. Preferably the cereal bran is rice bran.

Hence an embodiment of the present method of the invention is wherein the cereal bran is heated to 225° C. for 5 hours and the aroma compounds in the flavoring composition comprises 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 232 ppm or less. Preferably the cereal bran is rice bran.

Preferably the cereal bran is heated to 225° C. for 5 hours and the aroma compounds in the flavoring composition consist of 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 232 ppm or less. Preferably the cereal bran is rice bran.

Hence an embodiment of the present method of the invention is wherein the cereal bran is heated to 230° C. for 5 hours and the aroma compounds in the flavoring composition comprises 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 245 ppm or less. Preferably the cereal bran is rice bran.

Preferably the cereal bran is heated to 230° C. for 5 hours and the aroma compounds in the flavoring composition consist of 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 245 ppm or less. Preferably the cereal bran is rice bran.

Hence an embodiment of the present method of the invention is wherein the cereal bran is heated to 235° C. for 5 hours and the aroma compounds in the flavoring composition comprises 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 274 ppm or less. Preferably the cereal bran is rice bran.

Preferably the cereal bran is heated to 235° C. for 5 hours and the aroma compounds in the flavoring composition consist of 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 274 ppm or less. Preferably the cereal bran is rice bran.

Hence an embodiment of the present method of the invention is wherein the cereal bran is heated to 250° C. for 5 hours and the aroma compounds in the flavoring composition comprises 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 337 ppm or less. Preferably the cereal bran is rice bran.

Preferably the cereal bran is heated to 250° C. for 5 hours and the aroma compounds in the flavoring composition consist of 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol, E-isoeugenol, Z-isoeugenol, 4-vinyl phenol, 4-propyl guaiacol and 2,6-dimethoxyphenol. Preferably the amount of aroma compounds is approximately 337 ppm or less. Preferably the cereal bran is rice bran.

However, it is preferred that the cereal bran is heated to 235° C. or less.

The present inventors performed a series of experiments which are outlined in the accompanying examples. Within these experiments they measured the amount of aroma compounds which could be prepared from cereal brans heated in the presence or absence of air or nitrogen flow.

It can be seen from the data herein that the presence or air or nitrogen flow increased the amount of aroma compounds which could be from prepared cereal brans.

Hence a preferred embodiment of the method of the invention is wherein step (i) further comprises where the cereal bran is heated in the presence of air or nitrogen flow.

The absence of exogenous water is preferred since water can act to alter the chemical reactions and alter the amount of aroma compound(s) and PAH in the composition of the invention.

In preferred embodiment of the method of the invention is wherein the method further comprises:
(iii) the addition of exogenous water to the heated cereal bran
(iv) collecting the arising hydrodistillate
(v) combining the hydrodistillate of step (iv) with the flavoring composition produced by step (ii)

In this embodiment some exogenous water to the heated cereal bran is added to allow for the heating reactions to complete after the exhaustion of the endogenous water.

The remaining steps in the method of the invention are clear and are also described below in the examples section of the application. Preferably the flavoring composition produced by step (i) is collected as a condensate, hydrodistillation or steam distillation.

A further aspect of the invention provides a flavoring composition prepared according to any of the methods of the invention.

The present invention also relates to the use of flavoring composition as a flavoring ingredient. In other words, it concerns a method or a process to confer, enhance, improve or modify the taste properties of a flavoring composition or of a flavored article, wherein the method comprises adding to said composition or article an effective amount of the invention's flavor profile, e.g. to impart its typical note.

Typical effective amounts are in the order of 0.001 ppm to 1000 ppm, more preferably 0.1 ppm to 500 ppm, more preferably 0.5 ppm to 350 ppm, most preferably 1 ppm to 100 ppm, of the invention's composition based on the weight of the composition or of the article into which it is incorporated.

By “use of a composition” it has to be understood here also the use of any composition of the invention which can be advantageously employed in the flavor industry.

By “taste”, it meant to designate the taste perception and the taste sensation.

Said compositions, which in fact can be advantageously employed as flavoring ingredients, are also an object of the present invention.

We also include where in this aspect of the invention where the flavoring composition of the invention or prepared according to any of the methods of the invention is provided in a diluted form. For example, the flavoring composition of the invention may be diluted to a concentration of 75%, 50%, 40%, 30%, 20%, 10%, 5%, 1%, 0.5%, 0.25%, 0.1%, 0.05%, 0.025%, 0.01% with for example water.

A further embodiment of the invention is wherein the flavor composition of the invention further comprises
i. at least one ingredient selected from the group consisting of a flavor carrier, a flavoring co-ingredient and a mixture thereof; and
ii. optionally at least one flavor adjuvant.

By “flavor carrier”, it is meant a material which is substantially neutral from a flavor point of view, insofar as it does not significantly alter the organoleptic properties of flavoring ingredients. The carrier may be a liquid or a solid.

Suitable liquid carriers include, for instance, an emulsifying system, i.e. a solvent and a surfactant system, or a solvent commonly used in flavors. A detailed description of the nature and type of solvents commonly used in flavor cannot be exhaustive. Suitable solvents include, for instance, propylene glycol, triacetine, caprylic/capric triglyceride (Neobee®), triethyl citrate, benzylic alcohol, ethanol, vegetable oils such as linseed oil, sunflower oil or coconut oil or terpenes.

Suitable solid carriers include, for instance, absorbing gums or polymers, or even encapsulating materials. Examples of such materials may comprise wall-forming and plasticizing materials, such as mono, di- or trisaccharides, natural or modified starches, hydrocolloids, cellulose derivatives, polyvinyl acetates, polyvinylalcohols, proteins or pectins, or yet the materials cited in reference texts such as H. Scherz, Hydrokolloid: Stabilisatoren, Dickungs-und Geliermittel in Lebensmitteln, Band 2 der Schriftenreihe Lebensmittelchemie, Lebensmittelqualität, Behr's VerlagGmbH & Co., Hamburg, 1996. Encapsulation is a well-known process to a person skilled in the art, and may be performed, for instance, using techniques such as spray-drying, agglomeration, extrusion, coacervation and the like.

By “flavoring co-ingredient” it is meant here a compound, which is used in flavoring preparations or compositions to impart a hedonic effect. In other words such an ingredient, to be considered as being a flavoring one, must be recognized by a person skilled in the art as being able to impart or modify in a positive or pleasant way the taste of a composition, and not just as having a taste.

The nature and type of the flavoring co-ingredients present in the flavoring composition do not warrant a more detailed description here, the skilled person being able to select them on the basis of its general knowledge and according to intended use or application and the desired organoleptic effect. In general terms, these flavoring co-ingredients belong to chemical classes as varied as alcohols, aldehydes, ketones, esters, ethers, acetates, nitriles, terpenoids, nitrogenous or sulphurous heterocyclic compounds and essential oils, and said perfuming co-ingredients can be of natural or synthetic origin. Many of these co-ingredients are in any case listed in reference texts such as the book by S. Arctander, Perfume and Flavor Chemicals, 1969, Montclair, New Jersey, USA, or its more recent versions, or in other works of a similar nature, as well as in the abundant patent literature in the field of flavor. It is also understood that said co-ingredients may also be compounds known to release in a controlled manner various types of flavoring compounds.

By “flavor adjuvant” we mean here an ingredient capable of imparting additional added benefit such as a color, a particular light resistance, chemical stability, and so on. A detailed description of the nature and type of adjuvant commonly used in flavoring compositions cannot be exhaustive. Nevertheless, such adjuvants are well known to a person skilled in the art who will be able to select them on the basis of its general knowledge and according to intended use or application.

A composition comprising at least the flavor composition of the invention and at least one flavor carrier represents a particular embodiment of the invention as well as a flavoring composition comprising at least flavor composition of the invention at least one flavor carrier, at least one flavor co-ingredient, and optionally at least one flavor adjuvant.

Furthermore, the flavor composition of the invention can be advantageously used in all the fields of flavor to positively impart or modify the taste of a consumer product into which said extract is added. Consequently, the present invention relates to a flavored consumer product comprising the flavor composition of the invention as defined above.

A further preferred embodiment of the invention is wherein the flavor composition of the invention further comprises one or more additional components selected from the group comprising: yeast extract (which includes amino acids and sugars), organic acids (including but not limited to tartaric, malic, citric, sodium diacetate, sodium disuccinate, lactic acid), herbs and spices. The composition may also comprise additional flavor agents including garlic, onion and sugar beet powders. Such additional components are well known in the art and can be readily obtained from suppliers to the food industry.

The flavor composition of the invention can be added to a flavored consumer product. It can be added as such or as part of an invention's flavoring composition.

For the sake of clarity, by “flavored consumer product” it is meant to designate an edible product which may be food or beverage and which can be fried or not, as well as frozen or not, low fat or not, marinated, battered, chilled, dehydrated, instant, canned, reconstituted, retorted or preserved. Therefore, a flavored article according to the invention comprises the invention's extract, as well as optional benefit agents, corresponding to taste and flavor profile of the desired edible product, e.g. a savory cube.

The nature and type of the constituents of the foodstuffs or beverages do not warrant a more detailed description here, the skilled person being able to select them on the basis of his general knowledge and according to the nature of said product.

Typical examples of said flavored consumer product include:
seasoning or condiment, such as a stock, a savory cube, a powder mix, a flavored oil, a sauce (e.g. a relish, a barbecue sauce, a dressing, a gravy or a sweet and/or a sour sauce), a salad dressing or a mayonnaise;
meat-based product, such as a poultry, beef or pork based product, a seafood, surimi, or a fish sausage;
soup, such as a clear soup, a cream soup, a chicken or beef soup or a tomato or asparagus soup;
carbohydrate-based product, such as instant noodles, rice, pasta, potatoes flakes or fried, noodles, pizza, tortillas, wraps;
dairy or fat product, such as a spread, a cheese, or regular or low fat margarine, a butter/margarine blend, a butter, a peanut butter, a shortening, a processed or flavored cheese;
savory product, such as a snack, a biscuit (e.g. chips or crisps) or an egg product, a potato/tortilla chip, a microwave popcorn, nuts, a bretzel, a rice cake, a rice cracker, etc;
imitation products, such as a dairy (e.g a reformed cheese made from oils, fats and thickeners) or seafood or meat (e.g. a vegetarian meat replacer, a veggie burger) or analogues;
pet or animal food; or
beverage such as a hot drink (e.g. a tea or coffee), a soft drink including carbonated, an alcoholic drink (e.g. whisky), a ready-to-drink or a powder soft.

Some of the above-mentioned flavored consumer products may represent an aggressive medium for the flavor composition of the invention, so that it may be necessary to protect the latter from premature decomposition, for example by encapsulation.

In a preferred embodiment, the flavor composition of the invention is added to the food product before the food product is thermally processed, i.e. before e.g. cooking, roasting, or grilling.

The proportions in which the flavor composition of the invention can be incorporated into the various of the aforementioned products vary within a wide range of values. These values are dependent on the nature of the consumer product to be flavored and on the desired organoleptic effect as well as the nature of the co-ingredients in a given base when the composition according to the invention are mixed with perfuming or flavoring ingredients, solvents or additives commonly used in the art.

For example, in the case of flavored consumer product, typical concentrations are in the order of 0.001 ppm to 1000 ppm, more preferably 0.1 ppm to 500 ppm, even more preferably 0.5 ppm to 350 ppm, most preferably 1 ppm to 100 ppm, of the invention's extract or composition based on the weight of the consumer product into which they are incorporated.

The quantity of the flavor composition of the invention in the flavored consumer product is dependent on the desired flavor profile of that product. For example, if the roast flavoring composition of the invention is intended to impart a roast aroma to a ham-type product, then the composition of the invention is mixed with a commercially available ham flavor. A similar approach was taken for beef, chicken and turkey flavorings. In addition products flavors were also added as needed, e.g. a hot dog flavor, burger flavor or a spicy sausage flavor.

A preferred embodiment of the invention is wherein the flavored consumer product is a meat substitute product comprising the flavor composition of the invention. Hence where the product is a “roast” or “smoked” product then the amount of composition can be 3 to 5% of the overall flavor composition used. Where the product is not a “roast” or “smoked” product then the amount can be 0.1% or less.

A meat substitute can be prepared by mixing a plant-derived protein, edible fibrous component, flavoring agent(s), and non-animal fat, adding an aqueous component such as water to the mixture and mixing to form a meat replacement substrate. The aqueous component can be heated before adding to the mixture of plant protein and fibrous component. Once formed, the meat substitute is heated to the appropriate temperature by grilling, boiling, frying etc.

As used herein, the term “plant-derived protein” includes wheat gluten, soy protein, dehydrin protein, an albumin, a globulin, conglycinin, glycinin, or a zein, or mixtures thereof) or plant protein fraction (e.g., a 7S fraction) has been separated from other components of the source materials. In some embodiments, the meat replica can be formulated to be gluten free, and, for example, a blend of maize starch, tapioca flour, rice flour, and guar gum can be substituted for the wheat gluten in the meat dough. Other examples of plant proteins that may be suitable used include, but are not limited to, pea protein, almond protein, cashew protein, canola (rapeseed) protein, chickpea protein, fava protein, sunflower protein, wheat protein, oat protein, potato protein, bitter melon protein, rice protein, corn protein, mung bean protein, and walnut protein. In some embodiments, the meat replacement product comprising the aroma compounds disclosed herein comprise pea protein.

In some alternative embodiments, non-animal proteins derived from fungi or algae can be used. Non-limiting examples of such algal proteins include proteins derived from spirulina or chlorella.

The “edible fibrous component” can be a plant fiber, an extruded mixture of isolated plant proteins (e.g., wheat gluten or other isolated plant protein, such as glutelins, albumins, legumins, vicillins, convicillins, glycinins and protein isolates such as from any seed or bean, including soy, pea, lentil, etc.), or a solution-spun protein fiber. The fibrousness and tensile strength of connective tissue replicas also can be modulated by changing the composition of the extrusion mixture. For example, by increasing the ratio of isolated plant protein (e.g., soy protein such as conglycinin) to wheat gluten to 3:1 w/w, and simultaneously decreasing water content in the extrusion mixture to 50%, a connective tissue replica with thinner fibers and larger tensile strength can be made. Some non-limiting examples of edible fibrous components include nut fibers, grain fibers, rice fibers, seed fibers, oat fibers, pea fibers, potato fibers, berry fibers, soybean fibers, banana fibers, citrus fibers, apple fibers, and carrot fibers. Some other non-limiting examples include fruit fiber (such as citrus fiber), grain fibers, psyllium husk fiber, natural soluble fibers and synthetic soluble fibers. Such natural fibers include soluble corn fiber, maltodextrin, acacia, and hydrolyzed guar gum. Such synthetic soluble fibers include polydextrose, modified food starch, and the like. Non-limiting examples of food-grade sources of soluble fiber include inulin, corn fiber, barley fiber, corn germ, ground oat hulls, milled corn bran, derivatives of the aleurone layer of wheat bran, flax flour, whole flaxseed bran, winter barley flake, ground course kilned oat groats, maize, pea fiber (e.g. Canadian yellow pea), Danish potatoes, konjac vegetable fiber (glucomannan), psyllium fiber from seed husks of planago ovate, psyllium husk, liquid agave fiber, rice bran, oat sprout fibers, amaranth sprout, lentil flour, grape seed fiber, apple, blueberry, cranberry, fig fibers, ciranda power, carob powder, milled prune fiber, mango fiber, apple fiber, orange, orange pulp, strawberry, carrageenan hydrocolloid, derivatives of eucheuma cottonnil seaweed, cottonseed, soya, kiwi, acacia gum fiber, bamboo, chia, potato, potato starch, pectin (carbohydrate) fiber, hydrolyzed guar gum, carrot, soy, soybean, chicory root, oat, wheat, tomato, polydextrose fiber, refined corn starch syrup, isomalto-oligosaccharide mixtures, soluble dextrin, mixtures of citrus bioflavonoids, cell-wall broken nutritional yeast, lipophilic fibers, plum juice, derivatives from larch trees, olygose fibers, derivatives from cane sugar, short-chain fructooligosaccharides, synthetic polymers of glucose, polydextrose, pectin, polanion compounds, cellulose fibers, cellulose fibers derived from hard wood plants and carboxymethyl cellulose. In some embodiments, the comestible composition comprises insoluble and insoluble fibers

The “non-animal fat” can include any suitable fats, oils, or combinations thereof. In some embodiments, the non-animal fat is an oil, meaning that it is a liquid (as opposed to a solid) at 20° C. Any suitable lipid can be used, including lipids derived from plants, fungi, algae, or any combinations thereof. In some embodiments, the non-animal fat is a plant-derived lipid or an algae-derived lipid. In some embodiments, the non-animal fat comprises omega-3 fatty acids or glycerides thereof, such as oils derived from microalgae, macroalgae, chia seed oil, hemp oil, walnut oil, flaxseed (linseed) oil, perilla oil, pumpkin seed oil, canola (rapeseed) oil, and any combination or fraction thereof. In some embodiments, the lipid component comprises flaxseed (linseed) oil, or a fraction thereof. In some embodiments, the non-animal fat comprises canola (rapeseed) oil, or a fraction thereof. In some embodiments, the non-animal fat comprises an algal oil, or a fraction thereof. Other oils can also be used, such as palm oil, palm kernel oil, coconut oil, fractions of any of the foregoing, an oil derived therefrom, or any combinations thereof. As used herein, the term “fraction” refers to a higher-melting or lower-melting portion of the oil that is separated from the rest of the oil, for example, by crystallization. Palm stearin is a common example of such a fraction, which is obtained by the slow crystallization of palm oil and the separation of the higher-melting portion that crystallizes when heated palm oil is cooled to a temperature near its melting point. Other examples include shea stearin, rice stearin, and the like. In this context, the term “derivative” refers to a synthetic glyceride that is formed by transesterifying the fatty acids of the oil to obtain a higher proportion of glycerides having shorter or longer fatty acid chains. For example, NEOBEE M5 (Stepan Co.) is an example of such a derivative, where coconut and palm kernel oil are transesterified to obtain a composition of triglycerides where the fatty acids are a combination of capric and caprylic acid. In some embodiments, the lipid component comprises at least 10% by weight, or at least 20% by weight, glycerides of alpha-linolenic acid, based on the total weight of glycerides in the non-animal fat. Free fatty acids derived from any of the aforementioned non-animal fats can also be used, such as lauric acid, capric acid, caprylic acid, stearic acid, palmitic acid, oleic acid, linoleic acid, linolenic acid, docosahexaenoic acid, eicosapentaenoic acid, and the like.

In some embodiments, such meat replica products contain certain savory tastants or compounds that enhance savory taste. Such umami tastants include, but are not limited to, N-(heptan-4-yl)benzo[d][1,3]dioxole-5-carboxamide, N¹-(2,4-dimethoxybenzyl)-N²-(2-(pyridin-2-yl)ethyl)oxalamide, alkyl amides, glutamates (such as monosodium glutamate (MSG)), arginates, purinic ribotides (such as inosine monophosphate (IMP), adenosine monophosphate (AMP), guanosine monophosphate (GMP), and sodium salts thereof), amino acids (such as L-threanine), yeast extracts, and alcohol. Some other such savory ingredients include, but are not limited to, a yeast extract, a fermented food product, a cheese, garlic or an extract thereof, a gamma-glutamyl-containing polypeptide, a gamma-glutamyl-containing oligopeptide (such as a gamma-glutamyl-containing tripeptide), a cinnamic acid amide or a derivative thereof, such as (E)-N-(4-cinnamamidobutyl)-4-hydroxy-2-methylbut-2-enamide, a nucleotide, an oligonucleotide, a plant extract, a food extract, avocadyne, avocadene, or any combination thereof. In some embodiments, the ingestible composition comprises a salty tastant, such as sodium chloride or potassium chloride.

In some further embodiments, the aroma compounds disclosed herein can be used in combination with one or more bitterness blocking compounds. Such bitterness blocking compounds include, but are not limited to, naturally derived compounds, such as menthol or analogs thereof, phloretin, naringenin, hesperetin dihydrochalcone, or other such flavanones or dihydrochalcones, or synthetic compounds, such as any compounds set forth in U.S. Pat. Nos. 8,076,491; 8,445,692; and 9,247,759. In some embodiments, the bitterness blocking compound is 3-(1-((3,5-dimethylisoxazol-4-yl)-methyl)-1H-pyrazol-4-yl)-1-(3-hydroxybenzyl)-imidazolidine-2,4-dione.

The texture of a meat dough also can be modified by adding cream of tartar to the preparation. For example, meat dough preparations containing cream of tartar may be more cohesive, with a form factor after grinding that is similar to ground beef, such that it is readily shaped. Cream of tartar can be added between 0.05%> and 2.5% (e.g., 0.5%).

The appearance of the ground meat replica can be modulated by shredding the edible fibrous component into pieces of the desired size and shape. The size of the fibers can be adjusted to imitate the fibrous appearance of meat by the type of shredder, choice of blade, and screen type, and adjusting the time of shredding. The fibrousness, tensile strength, and appearance of the connective tissue replicas can be tailored to imitate specific ground meat products (e.g., ground beef or different cuts of beef that can be ground).

In some embodiments, the edible fibrous component includes soluble or insoluble plant fibers. For example, plant fibers from carrot, bamboo, pea, broccoli, potato, sweet potato, corn, whole grains, alfalfa, kale, celery, celery root, parsley, cabbage, zucchini, green beans, kidney beans, black beans, red beans, white beans, beets, cauliflower, nuts, apple skins, oats, wheat, or psyllium, or a mixture thereof, can be used as the edible fibrous component.

In some embodiments, meat doughs are formed using roughly equal proportions of isolated plant protein and edible fibrous component. It will be appreciated that the ratio can be varied as desired to tailor the properties of the end product.

After heating the meat dough as described above, a non-animal fat optionally containing a flavoring agent can be combined with the meat dough. Typically, the meat dough is allowed to cool (e.g., to room temperature) before combining the meat dough with the non-animal fat. The non-animal fat can be flavored by combining the non-animal fat with an iron complex or iron salt and one or more flavor precursors (described above) and heating the mixture to produce the flavor compounds. The heated mixture can be cooled so that the non-animal-based fat can solidify. One or more additional non-animal fats (e.g., algal oil), one or more masking agents (e.g., a lactone such as butyrolactone, delta-tridecalactone, gamma decalactone, delta-dodecalactone, y-octalactone, dihydro-5-methyl 2(3H)-furanone, 4-hydroxy-2,5-dimethyl-3(2H)-furanone, 5-ethyl-4-hydroxy-2-methyl-3(2H)-furanone, 6-tetradecalactone, or combinations thereof), or one or more flavoring compounds (e.g., acetoin, carotenoid, antioxidant, vegetable or fruit juice, puree, or extract) can be added before the mixture solidifies to improve the flavor of the non-animal fat.

Carotenoids can be added to the meat substitute by adding them into the flavor emulsion or the flavor broth. The carotenoids can be added before or after cooking. The carotenoids can be added between 0.00001% and 0.1%>. When the carotenoids are added before cooking, they can act as a substrate in the reaction flavor mixtures creating the flavors before their addition into a meat substitute.

Vegetables or fruits (juice, purees, or extracts) can be added to meat substitute to increase the perceived meat flavor (e.g., the meatiness) and likeability of the products, as well as increase the perceived fattiness and fat mouth coating. Additionally, they can cause tasters to have an increase in salivation when eating the products, leading to an increase in perceived juiciness in meat substitutes. The type of meat flavors that the vegetable or fruit enhances depends on the type and processing. Examples include added tallow fatty notes from cucumber and melons that are enhanced with cooking; added sweet aromatics, char meat, and savory notes from honeydew; added sweet aromatics, and freshness from pineapple and, added savory, browned meat flavor from tomato.

The binding agent can be an isolated plant protein or a carbohydrate-based gel. Non-limiting examples of suitable plant proteins include RuBisCO, an albumin, a gluten, a glycinin, a conglycinin, a legumin, a globulin, a vicilin, a conalbumin, a gliadin, a glutelin, a glutenin, a hordein, a prolamin, a phaseolin, a proteinoplast, a secalin, a triticeae gluten, a zein, an oleosin, a caloleosin, a steroleosin, or mixtures thereof (e.g., albumin fractions). The plant proteins can be obtained from any source, including soy, peas or lentils. In some embodiments, useful binding agents can be obtained from a non-plant-based source. For example, egg albumin or collagen can be used as a binding agent in some embodiments.

When the binding agent is a protein, it is useful for the denaturation temperature of the protein to be less than the melting temperature of the carbohydrate-based gel. For example, the denaturation temperature of suitable protein-binding agents (e.g., RuBisCO, albumin, soybean conglycinin, or a gluten, or mixtures thereof) can be between about 40° C. and about 80° C. This allows the carbohydrate based gel to melt after the protein binding agent denatures and binds the meat substitute together, and provides better texture and form to the meat substitute.

In some embodiments, the proteins used as binding agents may be chemically or enzymatically modified to improve their textural and/or flavor properties. For example, proteins may be partially proteolyzed using food-grade enzymes such as papain to result in better water-release profile during gelation and cooking. In some embodiments, the proteins used as binding agents may be chemically or enzymatically modified to modify the denaturation and gelling temperature of the proteins, for example, to achieve a specific gelling temperature (e.g., 52° C. to mimic myosin or 68° C. to mimic actin). In some instances, proteins such as proteases may be used to reduce bitterness that may be present in purified protein fractions.

In addition, an iron-complex and/or an iron salt and a flavoring agent can be added to the meat substitute. The iron-complex and/or iron salt can be the same or different than the iron-complex and/or iron salt used to flavor the meat dough, connective tissue substitute, or non-animal-based fat. The flavoring agent can be a flavor precursor or mixture of flavor precursors (described above) such that upon cooking the meat substitute, the iron-complex and/or iron salt and flavor precursor can react and produce flavor compounds. The flavoring agent also can be a flavoring such as yeast extract, hydrolyzed protein, or a flavor compound.

Flavor precursors can react, e.g., with the iron in a highly conjugated heterocyclic ring complexed to an iron ion or an iron salt, with each other, or with flavorings, upon heating. Accordingly, in the meat substitute described herein combinations of pre-cooked, i.e., reacted, flavor components, uncooked flavor precursors that can react (e.g., with the iron salt and/or highly conjugated heterocyclic ring complexed to an iron ion or with each other) during cooking of the substitutes, or flavorings or flavor compounds that introduce a flavor without requiring a reaction, can be incorporated into the meat replica to reproduce the sensory experience of cooking and eating cooked ground meat. The heme-containing protein can be a non-animal heme-containing protein, such as a plant-derived heme-containing protein (e.g., leghemoglobin). Further, in some embodiments, the heme-containing protein can be isolated or isolated and purified. In any of the methods or compositions described herein, the highly conjugated heterocyclic ring complexed to an iron ion can be a heme moiety, or a porphyrin, porphyrinogen, corrin, corrinoid, chlorin, bacteriochlorophyll, corphin, chlorophyllin, bacteriochlorin, or isobacteriochlorin moiety complexed to an iron ion. The heme moiety can be a heme-containing protein (e.g., a non-symbiotic hemoglobin, a Hell's gate globin I, a flavohemoprotein, a leghemoglobin, a heme-dependent peroxidase, a cytochrome c peroxidase, or a mammalian myoglobin). In some embodiments, the heme-containing protein can be a leghemoglobin. The leghemoglobin can be from soybean, pea, or cowpea.

In some embodiments, seasonings agents such as edible salts (e.g., sodium or potassium chloride), garlic, or herbs (e.g., rosemary, thyme, basil, sage, or mint), emulsifiers (e.g., lecithin), additional fiber (e.g., zein or inulin), minerals (e.g., iodine, zinc, and/or calcium), meat shelf life extenders (e.g., carbon monoxide, nitrites, sodium metabisulfite, Bombal, vitamin E, rosemary extract, green tea extract, catechins and other antioxidants) can be incorporated into the meat substitutes.

Meat substitutes described herein also can include a natural coloring agent such as turmeric or beet juice, or an artificial coloring agent such as an azo dye, triphenylmethane, xanthene, quinine, indigoid, titanium dioxide, red #3, red #40, blue #1, or yellow #5, or any combination of natural and/or artificial coloring agents.

Any of the substitutes described herein can be shaped to the desired use, e.g., formed into patties, loaves, chubs, meatballs, or nuggets, and used in any type of food product that ground meat would be used, e.g., as taco filling, or in casseroles, sauces, toppings, soups, stews, meatballs, or meatloaves. In some embodiments, a meat substitutes can be formed, for example, into meatballs or nuggets, and then coated with breadcrumbs, rice, or a flour (e.g., oat flour or coconut flour) for ease of convenience.

A preferred embodiment of the invention is wherein the meat fillet, nugget or hot dog substitute comprises 2 to 20% textured wheat or soy protein, 5 to 15% rapeseed or sunflower oil, 10 to 20% non-animal protein substitute, up to 2% salt, optionally 0.3 to 1% cellulose fibers, 0.1 to 5% flavor composition of the invention, made to 100% with water and additional flavoring components. Preferably the non-animal protein substitute is VIA VEG CNC obtainable from Campus Italy (www.campus-italy.com).

A preferred embodiment of the invention is wherein the meat burger substitute comprises 10 to 20% textured wheat or soy protein, 5 to 10% rapeseed or sunflower oil, 5 to 15% coconut flakes, 0.3 to 1% salt, 0.1 to 5% flavor composition of the invention, made to 100% with water and additional flavoring components.

The invention will now be described in further detail by way of the following examples which illustrate the benefits and advantages of the present invention.

### Example 1: Thermal Generation of Flavoring Phenols from Cereal Bran

### Abstract

Cereal brans were roasted in a round flask and the emerging condensate was collected. The influence of roasting time and temperature on the formation of selected target phenols was studied, as well as eight cereal bran varieties. From 100 g bran 30-35 ml distillate is obtained with up to 1.9 mg/g target phenols (including up to 0.9 mg/g guaiacol). Corn bran roasted at 235° C. for 3 h received the best sensory rating and was selected for prototyping. It was positively rated by flavorists, the starting raw material/corn bran is widely available as food-grade side product from starch production, and corn is not associated with food allergenicity.

### Introduction

The present inventors study generation of roast flavoring phenols by heating foodstuff that is rich in phenol precursors. Cereal brans were chosen because they are rich in ferulic and other phenylpropanoic acids¹¹, inexpensive, but have food status. The chosen temperatures of 200 to 250° C. are lower than temperatures of wood fire (≈600° C.) and similar to temperatures used for baking bread, roasting meat or black malt¹².

### 1. Results and Discussion

### 1.1. Phenol Target Odorants

Analyses focused on quantification of aroma relevant phenols. Phenols with concentrations above their odour threshold in food^{2, 13, 14}, were selected as target phenols (FIG. 2). Other relevant odorants like acetic acid and carbonyl compounds were outside the scope of the study.

### 1.2. Roasting of Rice Bran

In preliminary trials, rice bran (1-2 g) was heated in glass tubes at 200-350° C. for 2-4 h in a heated metal block. The condensing distillate was collected via a short-path distillation bridge.

Consequently, trials were continued at larger scale. Rice bran (100 g) was added to a round flask, which was connected via short path distillation to a cow-type receiver. The flask with the rice bran was immersed in a silicon oil bath, then heated to 235° C. for 5 h. Silicon oil with a high flash point (>300° C.) was used for safety reasons. Five fractions, each corresponding to 1 h, were collected during roasting. After 5 h the flask was removed from the oil bath, water (20 ml) added and distillation continued for another 30 min, and then the resulting distillate (fraction 6) collected.

Table 1 lists distillate volumes for each fraction. A total of 33 ml distillate was collected from 100 g bran, 20.6 ml during the first 5 h of heating (F1-F5) and 12.4 ml after water addition and continued distillation (F6). F3 was the richest fraction in target phenols, followed by F6. The phenol composition differed in the various fractions. 4-Vinylguaiacol (10) had a higher proportion in F1 (56%) and F2 (15%). In contrast, guaiacol (6) increased proportionally from F1 to F5. Fraction F6 had proportionally more 4-ethylphenol (5) and 4-ethylguaiacol (9) than guaiacol (6) compared to F1-F5. Possibly less 5 and 9 was carried over in the distillate during the first 5 hours due to their high boiling points (218° C. and 236° C.) compared to guaiacol (205° C.). After water addition, hydrodistillation may have been more efficient. Consequently, subsequent hydrodistillation after roasting may improve phenolic compound yield from bran.

TABLE 1
Phenols from roasting rice bran (100 g) at 235° C. for 5 h.

| | | F 1 | F 2 | F 3 | F 4 | F 5 | F 6 | total F1-F6 |
|---|---|---|---|---|---|---|---|---|
| | target phenol (μg) | 8.2* | 4.9* | 4.0* | 2.4* | 1.1* | 12.4* | 33.0* |
| 1 | 2-methylphenol | 8.6 | 98 | 182 | 137 | 53 | 151 | 630 |
| 2 | 3-methylphenol | 2.4 | 21 | 47 | 42 | 19 | 62 | 193 |
| 3 | 4-methylphenol | 4.5 | 28 | 75 | 76 | 38 | 155 | 377 |
| 4 | 3-ethylphenol | 0.0 | 0.2 | 0.6 | 1.3 | 0.6 | 3.1 | 6 |
| 5 | 4-ethylphenol | 27 | 211 | 728 | 640 | 256 | 1603 | 3465 |
| 6 | guaiacol | 201 | 2525 | 4935 | 4054 | 2364 | 2938 | 17017 |
| 7 | 4-methylguaiacol | 3.4 | 45 | 128 | 157 | 89 | 294 | 716 |
| 8 | 5-methylguaiacol | 0.6 | 2.3 | 1.1 | 0.6 | 0.5 | 1.2 | 6.2 |
| 9 | 4-ethylguaiacol | 5.9 | 137 | 597 | 577 | 228 | 1095 | 2640 |
| 10 | 4-vinylguaiacol | 333 | 564 | 248 | 74 | 104 | 432 | 1755 |
| 11 | eugenol | 6.4 | 27 | 86 | 50 | 17 | 73 | 259 |
| 12 | E-isoeugenol | 2.0 | 9.3 | 21 | 14 | 16 | 161 | 223 |
| 13 | Z-isoeugenol | 0.0 | 3.0 | 5.8 | 4.4 | 5.8 | 35 | 54 |
| | total compounds 1-13 | 595 | 3669 | 7054 | 5827 | 3191 | 7003 | 27339 |
| | (μg) | | | | | | | |

*Distillate volume (ml)

F1 to F5 are distillate fractions collected during 1-5 h heating. For F6, 20 ml water was subsequently added and distillation was continued for 30 min.

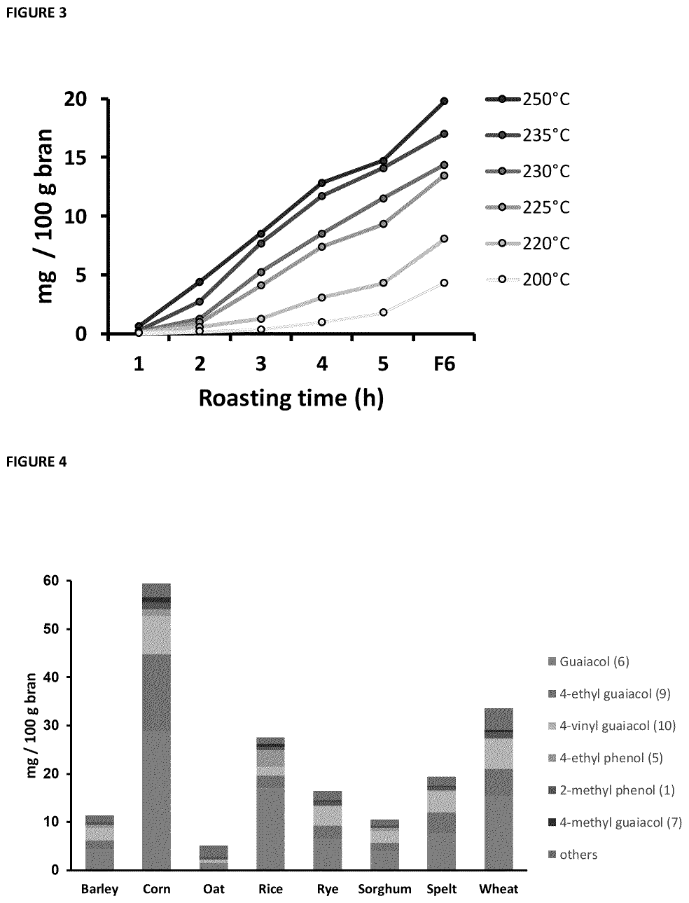

Heating time markedly influenced phenol yields. The guaiacol yield almost linearly increased over 5 hours at various temperatures (FIG. 3). A temperature of 235° C. produced 2.1-times more guaiacol (17.0 mg) than 220° C. (8.1 mg). Other studied phenols show a similar trend (cf. Table 2). The principal compound was guaiacol, followed by 4-ethylphenol, 4-ethylguaiacol and 4-vinylguaiacol. Their ratio was fairly constant from 220 to 250° C. (65:16:11:8). Because of its low odour threshold (21 μg/kg)¹⁵, 4-methylguaiacol probably also markedly contributes to the aroma. Its percentage of target phenols increases from 1 to 3.6% with temperature.

TABLE 2
Influence of roasting temperature on phenol formation from rice bran (100 g)

| | | 200° C. | 220° C. | 225° C. | 230° C. | 235° C. | 250° C. |
|---|---|---|---|---|---|---|---|
| | target phenol (μg) | 26.1* | 23.7* | 28.9* | 25.9* | 31.9* | 25.7* |
| 1 | 2-methylphenol | 184 | 407 | 592 | 624 | 630 | 736 |
| 2 | 3-methylphenol | 64 | 126 | 195 | 208 | 194 | 244 |
| 3 | 4-methylphenol | 81 | 168 | 300 | 324 | 376 | 571 |
| 4 | 3-ethylphenol | 1.5 | 3.8 | 7.4 | 7.2 | 6.1 | 11 |
| 5 | 4-ethylphenol | 1008 | 2094 | 3388 | 3615 | 3465 | 4768 |
| 6 | guaiacol | 4299 | 8056 | 13449 | 14337 | 17017 | 19767 |
| 7 | 4-methylguaiacol | 74 | 200 | 425 | 510 | 716 | 1205 |
| 8 | 5-methylguaiacol | 2.6 | 2.7 | 4.0 | 3.2 | 6.2 | 6.1 |
| 9 | 4-ethylguaiacol | 749 | 1377 | 2405 | 2478 | 2640 | 3438 |
| 10 | 4-vinylguaiacol | 1010 | 760 | 1545 | 1727 | 1754 | 2213 |
| 11 | eugenol | 122 | 204 | 311 | 312 | 258 | 374 |
| 12 | E-isoeugenol | 37 | 44 | 479 | 288 | 223 | 278 |
| 13 | Z-isoeugenol | 14 | 8.5 | 96 | 66 | 53 | 69 |
| | total compounds 1-13 | 7645 | 13450 | 23198 | 24499 | 27340 | 33681 |
| | (μg) | | | | | | |

*Distillate volume (ml)

Dry distillation for 5 h, then addition of water (20 ml) and further distillation for 30 min. A roasting temperature of 235° C. was chosen for subsequent trials, in order to stay below the limit of 240° C. for natural flavoring preparations in the EU¹⁶.

### 1.3. Influence of Cereal Variety

Different cereal brans have different nutrient compositions (carbohydrate, protein, fats). Likewise, the content in phenolic acids (e.g. ferulic and coumaric acid) varies¹¹ and hence can influence which phenols and how much is formed.

Eight bran types were roasted at 235° C. for 5 h. Corn bran generated most phenols (total 59 mg/100 g), followed by wheat bran (32 mg/100 g) and rice bran (27 mg/100 g) (Table 3). FIG. 4 shows that guaiacol is the dominant phenol in rice bran distillate, while in corn bran distillate 4-ethylguaicol and 4-vinylguaiacol have a comparatively large share. 4-Ethylphenol formation seems to be favourable from rice bran.

TABLE 3
Influence of cereal variety on phenol formation from roasting bran (100 g) at 235° C.

| | | Barley | Corn | Oat | Rice | Rye | Sorghum | Spelt | Wheat |
|---|---|---|---|---|---|---|---|---|---|
| | target phenol (μg) | 28.6* | 32.0* | 31.2* | 31.9* | 35.3* | 33.0* | 34.4* | 40.9* |
| 1 | 2-methyl phenol | 474 | 1370 | 596 | 630 | 839 | 450 | 740 | 1208 |
| 2 | 3-methyl phenol | 398 | 577 | 919 | 194 | 531 | 358 | 528 | 1229 |
| 3 | 4-methyl phenol | 299 | 501 | 300 | 376 | 250 | 287 | 292 | 544 |
| 4 | 3-ethyl phenol | 266 | 1029 | 71 | 6.1 | 541 | 245 | 531 | 831 |
| 5 | 4-ethyl phenol | 641 | 1381 | 31 | 3465 | 109 | 595 | 138 | 192 |
| 6 | guaiacol | 4294 | 28873 | 1298 | 17017 | 6373 | 3894 | 7536 | 15382 |
| 7 | 4-methyl guaiacol | 115 | 1161 | 36 | 716 | 197 | 107 | 226 | 604 |
| 8 | 5-methyl guaiacol | 0.0 | 1.1 | 11 | 6.2 | 0.0 | 0.0 | 0.4 | 42 |
| 9 | 4-ethyl guaiacol | 1918 | 15927 | 253 | 2640 | 2877 | 1815 | 4497 | 5655 |
| 10 | 4-vinyl guaiacol | 2560 | 7899 | 635 | 1754 | 4078 | 2441 | 4354 | 6136 |
| 11 | eugenol | 5.9 | 77 | 5.9 | 258 | 34 | 5.6 | 25 | 159 |
| 12 | E-isoeugenol | 9.7 | 93 | 14 | 223 | 81 | 10 | 51 | 384 |
| 13 | Z-isoeugenol | 5.5 | 36 | 1.7 | 53 | 10 | 5.4 | 9.2 | 45 |
| | total compounds 1-13 | 10987 | 58923 | 4170 | 27340 | 15919 | 10215 | 18928 | 32411 |
| | (μg) | | | | | | | | |

*Distillate volume

Dry distillation for 5 h, then addition of water (20 ml) and further distillation for 30 min.

### 1.4. Influence of Other Parameters

### Air Flow, Nitrogen Flow, Vacuum During Roasting.

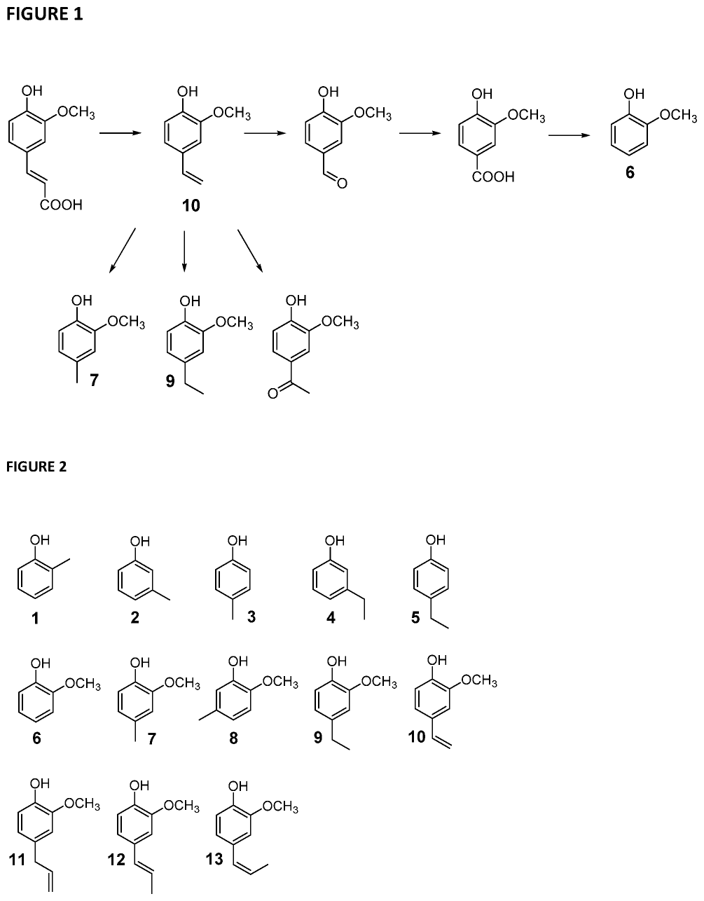

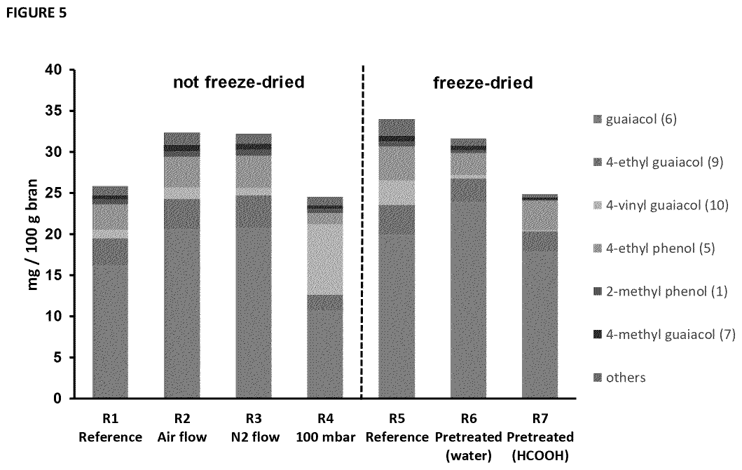

The presence or absence of air during roasting might influence phenol formation since some reaction steps involve oxidation (FIG. 1). Consequently, in a new series of experiments with a reference trial (R1), one with gentle flow of air (R2), a gentle flow of nitrogen (R3), and under reduced pressure (100 mbar, R4) was carried out (Table 4, illustrated FIG. 5). Flow of air, but also flow of nitrogen, increased the total amount of target phenols.

In contrast, vacuum (100 mbar) in general decreased the formation. Interestingly, 4-vinylguaiacol levels increased 8-times under vacuum. The reason for the high 4-vinylguaiacol concentration in R4 might be its lower boiling point at 100 mbar. As it is one of first reaction products formed, it might have distilled partially before being further degraded.

TABLE 4
Influence of various other parameters on phenol formation from roasting rice bran (100 g) at 235° C. (3 h)

| | | R1 | R2 | R3 | R4 | R5 | R6 | R7 |
|---|---|---|---|---|---|---|---|---|
| | pretreatment | | | | | | 150° C./15 h | 150° C./15 h |
| | | | | | | | (water) | (HCOOH) |
| | drying prior roasting | | | | | freeze- | freeze- | freeze- |
| | | | | | | dried | dried | dried |
| | roasting conditions | | air flow | N₂ | 100 mbar | | | |
| | | | | flow | | | | |
| | target phenol (μg) | 28.6* | 30.4* | 31.9* | 26.2* | 23.1* | 19.3* | 12.4* |
| 1 | 2-methylphenol | 591 | 704 | 726 | 512 | 616 | 363 | 68 |
| 2 | 3-methylphenol | 164 | 206 | 197 | 99 | 204 | 165 | 58 |
| 3 | 4-methylphenol | 215 | 302 | 282 | 159 | 292 | 218 | 134 |
| 4 | 3-ethylphenol | 13 | 13 | 11 | 4.7 | 12 | 0 | 0 |
| 5 | 4-ethylphenol | 3099 | 3724 | 3932 | 1342 | 4120 | 2688 | 3608 |
| 6 | guaiacol | 16211 | 20586 | 20798 | 10694 | 19940 | 23916 | 17837 |
| 7 | 4-methylguaiacol | 508 | 759 | 724 | 440 | 725 | 481 | 334 |
| 8 | 5-methylguaiacol | 8.9 | 3.8 | 4.2 | 4.7 | 5.5 | 4.2 | 1.8 |
| 9 | 4-ethylguaiacol | 3263 | 3716 | 3970 | 1944 | 3597 | 2861 | 2506 |
| 10 | 4-vinylguaiacol | 1039 | 1364 | 843 | 8583 | 2984 | 389 | 127 |
| 11 | eugenol | 360 | 376 | 362 | 284 | 403 | 215 | 118 |
| 12 | E-isoeugenol | 257 | 452 | 285 | 396 | 927 | 284 | 56 |
| 13 | Z-isoeugenol | 104 | 137 | 115 | 83 | 187 | 76 | 18 |
| | total compounds 1-13 | 25832 | 32342 | 32250 | 24545 | 34013 | 31661 | 24865 |
| | (μg) | | | | | | | |

*Distillate volume mL
*Distillate volume

Dry distillation for 3 h at 235° C., then addition of 20 ml and further distillation for 30 min. R2 and R3 were heated under a gentle flow of air or nitrogen, R4 was heated under vacuum. R6 and R7 were pre-treated with addition of water or aqueous formic acid and freeze-dried prior to roasting.

The pressure cooked samples R6 and R7 had a lower total phenol concentration than the freeze-dried reference R5 (Table 4, FIG. 5). Amount for all target phenols were lower in the water-treated sample R6 than in R5, in particular 4-vinylguaiacol (389 vs. 2984 μg). Only guaiacol was formed in larger amounts (24 vs. 20 mg). Likewise, in the formic acid-treated rice bran distillate of all target phenols had lower amounts. Apparently, pre-treatment did not give substantially different results for the target phenols than a reference trial. This avenue was not further pursued. Additionally, treatment conditions (150° C. under pressure) would exclude labelling as natural flavoring in the EU (limits are 120° C. for pressure cooking).

### 1.5. Toxic Compounds: Benzo[a]Pyrene and Acrylamide

Due to the high combustion temperature of wood, smoke flavorings give rise to health concerns, in particular the possible presence of polycyclic aromatic hydrocarbons (PAH). The EU regulation limits the concentration of PAH in flavorings. The lead compound benzo[a]pyrene (BaP) is limited to 10 μg/kg¹. Acrylamide is another potentially toxic compound in thermally treated food. The benchmark level for bran products that are breakfast cereals in the EU is 300 ppb¹⁸.

Two rice bran distillate samples (235° C., 5 h) were analysed for BaP and acrylamide by an external laboratory. The distillate after 5 h of heating (fractions 1-5) as well as the distillate after water addition and further distillation (fraction 6) were investigated. None of the samples contained BaP (Table 5). Acrylamide was detected in fraction 6, however at much lower level than the EU benchmark for acrylamide in breakfast cereals. Corn bran distillate will not be consumed as such, but applied at low levels in food. Therefore, the acrylamide level in the end product will even be lower, probably well below 1 ppb. In summary, these preliminary results indicate no risks caused by PAHs and acrylamide for the roasted cereal bran distillates.

TABLE 5
Concentration of benzo[a]pyrene (BaP)
and acrylamide in roasted rice bran distillates

| compound | conc. | fractions 1-5 ^{a} | fraction 6 ^{a} | LOQ | EU limit |
|---|---|---|---|---|---|
| benzo(a)pyrene | μg/kg | nd | nd | 0.5 | 10 ^{b} |
| (BaP) | | | | | |
| acrylamide | μg/kg | nd | 109.0 | 10 | 300 ^{c} |

^{a} Dry distillation of 100 g bran at 235° C. for 5 h (fractions 1-5), then addition of 20 ml and further distillation for 30 min (fraction 6)
^{b} EU regulation 2065/2003: limit in flavorings
^{c} EU regulation 2017/2158: benchmark level in breakfast cereals (bran products)

1.6. Sensory assessment by flavorists

Three roasted cereal extracts (rice, corn, wheat) were sent to several flavorists of various affiliates for their sensory comments. They were produced from cereal brans by dry distillation at 235° C. for 3 h, followed by water addition and further distillation for 30 min. These flavorings can find applications both in savoury foods (e.g. ham, sausages) and beverages (e.g. whisky). Therefore, feed-back was sought both from savoury and beverage flavorists. Their comments point to a suitable tasting concentration of 500 ppm

All three prototypes had roast-like character. Overall, the corn and wheat prototypes were preferred over the rice variant. Corn bran extract was overall preferred, and on top it is no major food allergen unlike wheat.

### 2. Conclusion

The hypothesis to use cereal bran as starting raw material for dry-heating to produce an ingredient with roast-like aroma as strongly sought after natural alternative to smoke flavorings was proven and is feasible. The resulting distillates have roast-like flavor with natural status.

### Summary:

Higher temperatures and longer reaction times lead to larger amounts of the targeted phenolic compounds.
Corn, wheat and rice bran performed best among the tested cereal brans.
Formation of toxic compounds, like benz[a]pyrene and acrylamide, seems insignificant.
Sensory feed-back from flavorists points to roasted corn bran distillate as preferred flavor.

### 2.1. Methods

Roasting (gram scale). Rice bran (1-2 g) was heated in a glass tube (10×1.5 cm, ground joint 14/20) in a high temperature dry block heater (Grant BT5D, Grant Instruments, Cambridge, UK) at 200-350° C. for 2-4 h. The resulting distillate was collected via a short-path distillation bridge.

Roasting (100 gram scale). Cereal bran (100 g) was added to a 500-ml round flask that connected via short path distillation to a cow-type receiver with receiving flasks. The flask was immersed in a silicon oil bath. Then heating was started. The oil bath was stirred by a magnetic stir bar using a magnetic stirrer (IKA RCT basic, Guangzhou, PRC). It was heated using a protected electric heating coil from Systag (Rueschlikon, Switzerland). Silicon oil with high flash point (>300° C.) was used for safety reasons. In a typical experiment, every hour one fractions was collected, in total 5 fractions. Then the round flask was removed from the oil bath, water (20 ml) was added via the short path distillation piece and then distillation was continued for another 30 min (fraction 6). All fractions were centrifugated and kept refrigerated for analysis.

Thermal pre-treatment of bran. As reference, rice bran (100 g) was freeze-dried using an Alpha 1-4 LSCbasic freeze-drier (Martin Christ, Osterode, Germany). For pre-treatment with water, rice bran was homogeneously mixed with water (1:2.5 w/w) and added to a 100-ml digestion autoclave (Xi'an Instruments Ltd., PRC), which was placed in a laboratory oven (Binder ED 23, Binder, Shanghai, PRC) at 150° C. After 15 h the autoclave was let come to room temperature, and the pre-treated bran slurry was freeze-dried. A similar experiment was carried out with 10% formic acid instead of water.

### 3. References

1. European Parliament. REGULATION (EC) No 2065/2003 OF THE EUROPEAN PARLIAMENT AND OF THE COUNCIL of 10 Nov. 2003 on smoke flavorings used or intended for use in or on foods. Official Journal of the European Union 2003, 46, L 309/1.
2. Kosowska, M.; Majcher, M. A.; Jelen, H. H.; Fortuna, T., Key Aroma Compounds in Smoked Cooked Loin. J Agric Food Chem 2018, 66, 3683-3690.
3. Varlet, V.; Serot, T.; Cardinal, M.; Knockaert, C.; Prost, C., Olfactometric determination of the most potent odor-active compounds in salmon muscle (Salmo salar) smoked by using four smoke generation techniques. J Agric Food Chem 2007, 55, 4518-25.
4. Poisson, L.; Schieberle, P., Characterization of the Most Odor-Active Compounds in an American Bourbon Whisky by Application of the Aroma Extract Dilution Analysis. J Agric Food Chem 2008, 56, 5813-5819.
5. Giri, A.; Zelinkova, Z.; Wenzl, T., Experimental design-based isotope-dilution SPME-GC/MS method development for the analysis of smoke flavoring products. Food Addit Contam Part A Chem Anal Control Expo Risk Assess 2017, 34, 2069-2084.
6. Cadwallader, D. E., Wood smoke flavor. In Handbook of Meat, Poultry and Seafood Quality, Nollet, L. M. L., Ed. 2007.
7. Knowles, M. E.; Gilbert, J.; McWeeny, D. J., Phenols in smoked cured meats. Phenolic composition of commercial liquid smoke preparations and Derived Bacon. J Sci Food Agr 1975, 26, 189-196.
8. Baloga, D. W.; Reineccius, G. A.; Miller, J. W., Characterization of ham flavor using an atomic emission detector. J Agric Food Chem 1990, 38, 2021-2026.
9. Wittkowski, R.; Ruther, J.; Drinda, H.; Rafiei-Taghanaki, F., Formation of Smoke Flavor Compounds by Thermal Lignin Degradation. In Flavor precursors, Teranishi, R., Ed. ACS: Washington DC, 1992; pp 232-243.
10. Fiddler, W.; Parker, W. E.; Wasserman, A. E.; Doerr, R. C., Thermal decomposition of ferulic acid. J Agric Food Chem 1967, 15, 757-761.
11. Mattila, P.; Pihlava, J.-M.; Hellstroem, J., Contents of Phenolic Acids, Alkyl- and Alkenylresorcinols, and Avenanthramides in Commercial Grain Products. J Agric Food Chem 2005, 53, 8290-8295.
12. Hornsey, I. S., Malting. In Brewing, Royal Society of Chemistry: Cambridge, 2013; pp 25-65.
13. Shu, N. Starkenmann, C. Cured ham knowledge. Analysis of two European ham selected as golden standards; 2013, 5816-R.
14. Poisson, L. Charakterisierung der Schlüsselaromastoffe in amerikanischem Bourbon Whisky und schottischem Single Malt Whisky. PhD thesis. Technical University Munich, 2003.
15. https//www.leibniz-lsb.de/en/databases/leibniz-lsbtum-odorant-database/copyright-and-citation/
16. European Parliament. REGULATION (EC) No 1334/2008 OF THE EUROPEAN PARLIAMENT AND OF THE COUNCIL of 16 Dec. 2008 on flavorings and certain food ingredients with flavoring properties for use in and on foods and amending Council Regulation (EEC) No 1601/91, Regulations (EC) No 2232/96 and (EC) No 110/2008 and Directive 2000/13/EC. Official Journal of the European Union 2008, 51, L354/34.
17. Esposito, D.; Antonietti, M., Redefining biorefinery: the search for unconventional building blocks for materials. Chem Soc Rev 2015, 44, 5821-35.
18. European Commission. COMMISSION REGULATION (EU) 2017/2158 of 20 Nov. 2017 establishing mitigation measures and benchmark levels for the reduction of the presence of acrylamide in food. Official Journal of the European Union 2017, 60, L 304/24.

### Example 2: Example Use of the Flavor Compositions of the Invention

The present inventors investigated further the use of the flavor compositions of the invention in foodstuff.

### The Roast Flavoring Composition

The inventors first prepared an extract from cereal brans using the protocol outlined in example 1 above, using corn as a preferred example. The extract had the same composition profile as disclosed in that example.

The inventors then added a number of additional compounds to the extract to enhance the roast flavoring. These additional compounds were methylcyclopentenolone, furfuryl, furfural, furaneol, and thiazoline with additionally ethyl lactate, thymol and trimethylamine added to the mixture. The inventors then used this flavor composition as a “base” roast flavor composition.

Additional components were then added to the “base” roast flavor composition. These included yeast extracts (which includes amino acids and sugars), organic acids (including but not limited to tartaric, malic, citric, sodium diacetate, sodium disuccinate, lactic acid), herbs and spices. The flavor composition also comprised additional flavor agents including garlic, onion and sugar beet powders. All these additional components are well known in the art and can be readily obtained from suppliers to the food industry.

The resulting flavor composition therefore contains the flavor composition of the invention having a roast aroma profile and components commonly used in the flavor industry to enhance the flavoring effect.

### Uses of the Roast Flavoring Composition of the Invention

The inventors subsequently prepared a number of consumer product-like foods which include the roast flavoring composition of the invention. Example uses are provided herein.

Additional agents were added to the roast flavoring composition of the invention according to the intended flavor use. For example, if the roast flavoring composition of the invention is intended to impart a roast aroma to a ham-type product, then the composition of the invention is mixed with a commercially available ham flavor. A similar approach was taken for beef, chicken and turkey flavorings. In addition products flavors were also added as needed, e.g. a hot dog flavor, burger flavor or a spicy sausage flavor.

The inventors then prepared a meat substitute product incorporating the flavor compositions outlined above.

Typical meat substitute can be prepared by mixing a plant-derived protein, edible fibrous component, flavoring agent(s), and non-animal fat, adding an aqueous component such as water to the mixture and mixing to form a meat replacement substrate. The aqueous component can be heated before adding to the mixture of plant protein and fibrous component. Once formed, the meat substitute is heated to the appropriate temperature by grilling, boiling, frying etc.

The plant-derived protein used was pea protein or wheat gluten, or other such ingredients, depending on the substitute product to be prepared. Similarly, the “edible fibrous component” can be a plant fiber, an extruded mixture of isolated plant proteins

The fibrousness and tensile strength of connective tissue replicas also can be modulated by changing the composition of the extrusion mixture. For example, by increasing the ratio of isolated plant protein (e.g., soy protein such as conglycinin) to wheat gluten to 3:1 w/w, and simultaneously decreasing water content in the extrusion mixture to 50%, a connective tissue replica with thinner fibers and larger tensile strength can be made.

The non-animal fat used was typically sunflower oil, but alternative oil such as palm or coconut oil can be used.

Example products are outlined below.

### Vegan Hot Dog:

A vegan hot dog product was prepared by mixing the following ingredients: vegetable oil, preferably sunflower oil; plant protein: plant fibers, water and of the flavoring composition of the invention with other typical spices, salts, acids, and natural color notes. A binding agent was included and the resulting mixture shaped to a hot dog product.

### Vegan Burger Dog:

A vegan hot dog product was prepared by mixing plant derived protein (wheat, soy), vegetable oils and solid vegetable fats, plant fibers, water and the flavoring composition of the invention with other typical spices, salts, acids, and natural color notes. A binding agent was included and the resulting mixture shaped to a vegan burger dog product.

### Chicken Nuggets

A chicken nugget product was prepared by mixing grilled chicken, corn starch, water, and the flavoring composition of the invention with other typical spices, salts, acids, and natural color notes. A binding agent was included and the resulting mixture shaped to a chicken nugget product.

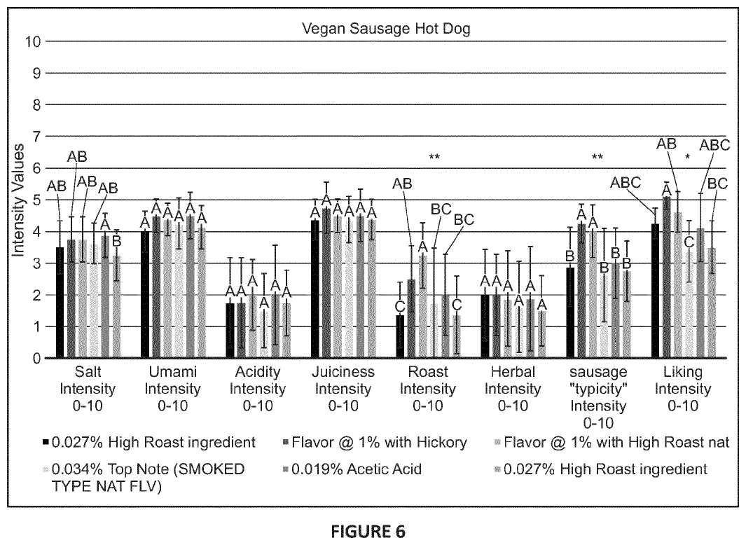

These product recipes were prepared using standard manufacturing processes. The resulting products were tested and found to have a pleasurable roast aroma when compared to test products without the flavor composition of the invention. A example of such results is shown in FIG. 6.

Hence the inventors have prepared an example range of vegetarian and non-vegetarian products incorporating the roast aroma composition of the invention. The example range clearly supports the claimed use of flavor composition of the invention in a range of meat and meat-substitute products

1. A flavoring composition having roast-like aroma profile comprising:
(i) a first aroma compound obtained by roasting a cereal bran, which is selected from the group consisting of: 2-methyl phenol, 3-methyl phenol, 4-methyl phenol, 3-ethyl phenol, 4-ethyl phenol, guaiacol, 4-methyl guaiacol, 5-methyl guaiacol, 4-ethyl guaiacol, 4-vinyl guaiacol, eugenol E-isoeugenol, Z-isoeugenol, 4-vinyl phenol, 4-propyl guaiacol and 2,6-dimethoxyphenol; and
(ii) a second aroma compound, which is selected from the group consisting of: ethyl lactate, thymol, trimethylamine, methylcyclopentenolone, furfuryl, furfural, furaneol, and thiazoline;
wherein the flavoring composition comprises less than 300 ppb of polycyclic aromatic hydrocarbons and comprises less than 300 ppb of acrylamides.

2. (canceled)

3. (canceled)

4. The flavoring composition of claim 1, wherein the flavoring composition comprises less than 10 ppb of polycyclic aromatic hydrocarbons.

5. (canceled)

6. (canceled)

7. The flavoring composition of claim 1, wherein the cereal bran is corn bran.

8. The flavoring composition of claim 1, wherein the cereal bran is wheat bran.

9. The flavoring composition of claim 1, wherein the cereal bran is rice bran.

10-15. (canceled)

16. A flavored consumer product comprising a flavoring composition of claim 1.

17. (canceled)

18. The flavored consumer product of claim 16 comprising the flavoring composition at a concentration of 10-2000 mg/kg.

19. A method of imparting a roast aroma to a flavored consumer product, the method comprising introducing to the flavored consumer product the flavoring composition of claim 1.
